(19) United States
(12) Patent Application Publication
(10) Pub. No.: US 2021/0025660 A1
(43) Pub. Date: Jan. 28, 2021

(54) SYSTEM AND METHOD FOR ACTIVE COOLING OF A SUBSTANCE

(71) Applicant: FROSTY COLD, LLC, Overland Park, KS (US)

(72) Inventors: JOHN R. BERGIDA, SAINT CHARLES, MO (US); DAVID D. LEAVITT, EDMOND, OK (US)

(21) Appl. No.: 16/520,946

(22) Filed: Jul. 24, 2019

(51) Int. Cl. F28D 20/02; C09K 5/06

(52) U.S. Cl. CPC F28D 20/023; A47G 23/04; C09K 5/063

(57) ABSTRACT

A system for cooling a substance that includes a heat transfer device with a coolant contained within the heat transfer device. The coolant has a first phase change temperature such that when the coolant is cooled below a phase change temperature the coolant transitions from a liquid to a solid phase. The system further includes a substance that has a second phase change temperature. The substance is positioned in close proximity to the heat transfer device such that thermal energy is transferred away from the substance into the coolant. The coolant may repeatedly undergo a phase change with re-exposure to a temperature below the phase change temperature and the heat transfer device requires no other activation than cooling below the first phase change temperature to commence thermal energy transfer with the substance.

### TECHNICAL FIELD

The system and method disclosed herein relate to the cooling of a substance with a phase change material.

### BACKGROUND

Heat Transfer Concepts

Heat transfer is a discipline of thermal engineering that concerns the generation, use, conversion, and exchange of thermal energy (heat) between physical systems. Heat transfer is classified into various mechanisms, such as thermal conduction, thermal convection, thermal radiation, and transfer of energy by phase changes. Heat conduction, also called diffusion, is the direct microscopic exchange of kinetic energy of particles through the boundary between two systems. When an object is at a different temperature from another body or its surroundings, heat flows so that the body and the surroundings reach the same temperature, at which point they are in thermal equilibrium. Such spontaneous heat transfer always occurs from a region of high temperature to another region of lower temperature, as described in the second law of thermodynamics.

Heat convection occurs when bulk flow of a fluid (gas or liquid) carries heat along with the flow of matter in the fluid. The flow of fluid may be forced by external processes, or sometimes (in gravitational fields) by buoyancy forces caused when thermal energy expands the fluid (for example in a fire plume), thus influencing its own transfer. The latter process is often called “natural convection”. All convective processes also move heat partly by diffusion, as well. Another form of convection is forced convection. In this case the fluid is forced to flow by use of a pump, fan or other mechanical means.

On a microscopic scale, heat conduction occurs as hot, rapidly moving or vibrating atoms and molecules interact with neighboring atoms and molecules, transferring some of their energy (heat) to these neighboring particles. In other words, heat is transferred by conduction when adjacent atoms vibrate against one another, or as electrons move from one atom to another. Conduction is the most significant means of heat transfer within a solid or between solid objects in thermal contact. Fluids—especially gases—are less conductive. Thermal contact conductance is the study of heat conduction between solid bodies in contact. Steady state conduction is a form of conduction that happens when the temperature difference driving the conduction is constant, so that after an equilibration time, the spatial distribution of temperatures in the conducting object does not change any further. In steady state conduction, the amount of heat entering a section is equal to amount of heat coming out.

Phase Change Materials

A phase change material is a substance with a high heat of fusion which, melting and solidifying at a certain temperature can store and release large amounts of energy. Heat is absorbed or released when the material changes from solid to liquid and vice versa; thus, phase change materials are classified as latent heat storage units. Unlike conventional sensible heat storage materials, however, when phase change materials reach the temperature at which they change phase (their melting temperature) they absorb large amounts of heat at an almost constant temperature. When the ambient temperature around a liquid material falls, the phase change material solidifies, releasing its stored latent heat.

The ideal phase change material is stable, chemically inert, and non-flammable. As well, it also has a high latent heat of phase change, remains solid through the phase change, and has high thermal conductivity to maximize the efficiency of the heat-transfer during the phase change. Unfortunately, many materials which would otherwise make very attractive phase change materials, such as paraffin and natural oils, like coconut oils, are flammable, lose structural integrity with their phase change and suffer from low thermal conductivity.

Initially, solid-liquid phase change materials behave like sensible heat storage materials; their temperature rises as they absorb heat. Unlike conventional sensible heat storage materials, however, when phase change materials reach the temperature at which they change phase (their melting temperature) they absorb large amounts of heat at an almost constant temperature. The phase change materials continue to absorb heat without a significant rise in temperature until all the material is transformed to the liquid phase. When the ambient temperature around a solid material rises, the phase change material liquifies, absorbing latent heat.

A specific latent heat (L) expresses the amount of energy in the form of heat (Q) required to completely effect a phase change of a unit of mass (m), usually 1 kg, of a substance as an intensive property:

L=Q/m

Intensive properties are material characteristics and are not dependent on the size or extent of the sample. Commonly quoted and tabulated in the literature are the specific latent heat of fusion and the specific latent heat of vaporization for many substances.

From this definition, the latent heat for a given mass of a substance is calculated by

Q=m/L

where:

Q is the amount of energy released or absorbed during the change of phase of the substance (in kJ or in BTU),

m is the mass of the substance (in kg or in lb), and

L is the specific latent heat for a particular substance (kJ kg⁻¹ or in BTU lb⁻¹), either L_{f} for fusion, or Lᵥ for vaporization.

Salt Hydrates

Prior references by the same inventors disclose the use of specific formulations of salt hydrates to address cooling needs. In particular, U.S. Pat. Nos. 10,155,698; 9,879,897 and 9,039,924 discuss at various levels of detail the use of salt hydrates for cooling purposes. The particular advantages of salt hydrates as a phase change material are: (1) their high volumetric latent heat storage capacity; (2) availability and low cost; (3) sharp melting point; (4) high thermal conductivity; (5) high heat of fusion; and (6) non-flammable. Some of the disadvantages of salt hydrates are (1) incongruous melting and phase separation upon cycling which can cause a significant loss in latent heat enthalpy; (2) corrosive to many other materials, such as metals; (3) change of volume is very high; (4) super cooling is a major problem in solid-liquid transition; and (5) nucleating agents are needed and they often become inoperative after repeated cycling.

The consumer market is presently woefully lacking in active cooling of consumables such as beverages and of frozen foods to include ice cream and frozen meals. One example of a product in this market is a cold wrap label that contains a phase change material that absorbs heat and suggests it can keep the beverage cool. Even less functional are systems that employ thermo-chromic ink coatings on aluminum cans that can identify the coldness level but do not facilitate cooling of the consumables. Another product on the market that does not provide active cooling is the “cooler box” developed by Coors® for cooling large numbers of bottles of beer. This product requires the filling of the wax or plastic liner lined cardboard box with ice cubes and the placement of the beer bottles into the ice cubes. This concept does not provide active cooling at the level taught or disclosed herein as the “cooler box” system is consistent with an approach that has been used for many decades to cool an object using ice.

What is missing in the market is an active cooling capability that relies upon, for example in one embodiment, a salt hydrate formulation that freezes solid at typical residential refrigeration temperatures in the range of 35° to 38° F. This cooling capability would preferably activate automatically when removed from the refrigerator and can maintain an appropriately sized object or substance at a designated temperature by relying upon the latent heat of storage of the salt hydrate phase change material. The formulation would preferably remain below 45° F. for about 3.5 hours when testing, for example, a 200-gm (7 ounce) sample [appropriate for cooling most commercial consumables] with no insulation at an ambient temperature of 70° F. The ideal system would be functionally adaptable with secondary packaging as well as capable of providing active cooling with no physical activation, i.e., shaking or removing a tab, etc., required by the user.

This same system integrated with secondary packaging would also ideally be capable of repeated phase change cycling without degradation of cooling capability.

None of the prior approaches have been able to provide an active cooling capability that accomplishes the goals of consistent cooling capabilities at an economical cost and that can be conformed to the needed size and shape.

### SUMMARY

The system and method disclosed herein are directed to keeping an object or substance cool for prolonged periods of time with an active cooling device that can be repeatedly cooled as necessary for reuse later. An exemplary, but certainly not exclusive, application of the system and method disclosed herein pertains to white wines which are preferably served chilled and ideally at temperatures anywhere from 40° to 50° F. This temperature range is warmer than the set point for most refrigerators.

When a boxed wine is served it may be placed on a table or a bar for an extended period while guests or patrons consume the wine contents over the course of the evening or event. The plastic bag which contains the wine collapses around the wine as the wine is withdrawn from the plastic bag to prevent incursion of air that may, over time, adversely affect the taste of the wine.

With the passage of time, the temperature of the wine within the plastic bag that is housed within the cardboard box tends to increase depending primarily upon ambient temperature and exposure to direct sunlight if in an outside open-air setting. Extremely warm ambient temperatures can result in rapid warming of the wine resulting in a beverage that when consumed is less flavorful than desired by either the producer of the wine or the individual providing the wine for consumption. Consequently, with the passage of time, the temperature of the wine begins to exceed the ideal serving temperature range from 40° to 50° F.

One remedy to address increasing wine temperatures is to return the wine box to the refrigerator for supplemental cooling; however, this can be a logistically challenging endeavor particularly if the setting lacks powered refrigeration capacity, such as at a secluded outdoor setting, or there are insufficient human resources to orchestrate the movement of wine boxes to and from the refrigerators. Alternatively, the box can be left inside of a cooler; however, placement therein can lead to the beverage being overlooked by patrons or guests or is simply cumbersome to access.

The system and method disclosed herein provide for an active cooling system that is preferably, but not necessarily, built into, for example, the base of the wine box and adjacent the plastic bag containing the wine. The system and method utilizes a flexible cooling pack that conforms to the shape of the object requiring cooling. Critically, the flexible cooling pack contains a latent heat storage unit that is comprised of a phase change material. As discussed above, when these phase change materials reach the temperature at which they change phase (their melting temperature) they absorb large amounts of heat at an almost constant temperature thereby providing active cooling primarily by conduction of heat away from the object or substance to which the phase change material is located.

The phase change material is formulated with a liquid-to-solid phase change temperature in the range of that found in a traditional residential refrigerator. For example, the flexible cooling pack undergoes a phase change from liquid to solid at approximately 38° F. The phase change material undergoes an exothermic reaction as the solution freezes. When the flexible cooling pack in its frozen and inflexible state is removed from the refrigerator and placed into the ambient environment the phase change material undergoes an endothermic reaction and absorbs energy, primarily through heat conduction, from the surrounding environment.

The system and method disclosed herein comprise either a flexible, conformable walled cold pack or a rigid walled cold pack that is configured to facilitate the transfer of heat from the object of substance to the phase change material housed within the cold pack.

It is another object of the system and method disclosed herein for the cold pack to provide cooling for an extended time interval to provide optimal benefit.

It is another object of the system and method disclosed herein to be unobtrusive to the consumer. In other words, the consumer will not know that an active cooling device is disposed within the container housing the liquids or object sought to be cooled.

It is an object of the system and method disclosed herein to employ a phase change liquid that changes phase from liquid to solid at temperatures typically found within commercial and residential refrigerators and freezers.

These and other objects, advantages and features of the disclosed system and method will become more apparent when the detailed description is studied in conjunction with the drawings, in which like elements are designated by the same reference characters in the various figures.

In accordance with these and other objects which will become apparent hereinafter, the disclosed system will now be described with particular reference to the accompanying drawings.

Various objects, features, aspects and advantages of the disclosed subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims.

### BRIEF DESCRIPTION OF THE DRAWINGS

FIG. 1 illustrates a perspective cutaway view of an exemplary embodiment of the disclosed heat transfer device system disposed within a container, the contents of which require cooling;

FIG. 2 illustrates a perspective cutaway view of an exemplary embodiment of the disclosed heat transfer device system disposed within a container, the contents of which require cooling;

FIG. 3 illustrates a perspective cutaway view of an exemplary embodiment of the disclosed heat transfer device system disposed within a container, the contents of which require cooling;

FIG. 4 illustrates a perspective cutaway view of an exemplary embodiment of the disclosed heat transfer device system disposed within a container, the contents of which require cooling;

FIG. 5 illustrates a time versus temperature graphical display for a product with and without active cooling;

FIG. 6 illustrates a histogram of hours of cooling provided for a product with and without active cooling;

FIG. 7A illustrates a metallic beverage container with an embodiment of the cooling device secured to the base of the container;

FIG. 7B illustrates a glass beverage container with an embodiment of the cooling device secured to the base of the container;

FIG. 8 illustrates a time versus temperature graphical display for several products with active cooling and one without active cooling;

FIG. 9 illustrates a time versus temperature graphical display for multiple embodiments of insulated containers as compared to an uninsulated container;

FIG. 10 illustrates an embodiment of a cooling device disposed at the bottom surface of an ice cream container undergoing filling with product;

FIG. 11 illustrates multiple container configurations and one disclosed container embodiment;

FIG. 12 graphically illustrates test results of increasing temperature of containers over time following removal from a temperature sufficient to extract heat of solidification; and

FIG. 13 illustrates an embodiment of a cooling pad device containing a coolant.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

The system and method disclosed herein is directed to an active cooling system that delivers cooling to an object or a substance such as beverages in a glass, aluminum or cardboard container or possibly even a human knee or shoulder. The objective of the system and method is to provide consumers with a significant benefit by maintaining beverages or other substances/objects cooler for a longer period without the need for ice or the need to place the object or substance in a refrigerator or freezer during the specified time interval.

The system and method disclosed herein are capable of many different configurations. Some of those configurations are detailed in the following paragraphs; however, the descriptions set forth below should not be considered to limit the scope or number of embodiments that are contemplated. The system and method disclosed herein is directed specifically to active cooling and not to passive insulation of an already cooled consumable product. For example, a neoprene Koozie® cup is exemplary of passive insulation. Passive insulation does retard the passage of heat energy through the wall of the beverage container; however, benchmark testing reveals that passive insulation systems are far less capable of resisting temperature increases over time than the active cooling system disclosed herein.

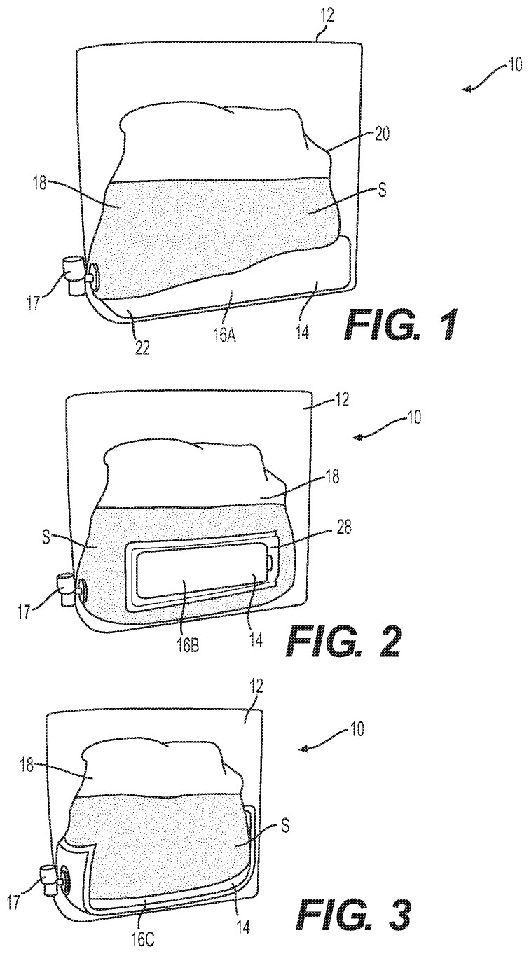

Various exemplary embodiments of the system 10 are illustrated at FIGS. 1-4, detailing cooling packs for the interior of, for example, a commercial beverage box 12. The coolant 14 comprising a composition detailed below is housed in a leak-proof heat transfer device 16. The heat transfer device 16 is positioned adjacent a flexible plastic pouch 18 containing a substance S for which cooling is desired. The substance S may optionally be a liquid, a gel, a semi-solid material or even a solid material and may be a liquid consumable, a pharmaceutical or a biological product among others. The coolant 14 has a phase change temperature T1 wherein the coolant 14 transitions from a liquid phase to a solid phase.

The heat of solidification is the energy that is given off by the liquid when it changes from liquid to a solid phase. This phase change occurs in a typical commercial setting when the system 10, and specifically the heat transfer device 16 with encased coolant 14, is placed within a refrigerator or freezer to lower the temperature to below the phase change temperature. Water, for example has a heat of solidification of 333.55 kJ/kg. This amount of energy is released from one kilogram of water when it changes phase from liquid water to ice. Conversely, the same amount of energy is required for input to the ice per kilogram to covert it from ice to liquid water. Other materials having different heats of solidification and fusion are discussed below.

The cooled substance S is in at least one of contact and close-proximity to the heat transfer device 16 such that thermal energy is transferred away from the substance S into the coolant 14 by at least one of conduction and convection through the wall 20 of the plastic pouch 18 and then through the wall 22 of the heat transfer device 16. The coolant 14 may repeatedly undergo phase change from liquid to solid phase upon re-exposure to a temperature below the phase change temperature T1, such as when the consumer returns the entire cooling system 10 to a refrigerated space.

FIG. 1 reveals a first embodiment of a boxed wine cooling system with a sloped variant of the coolant 14 in a heat transfer device 16A. The substance S to be cooled is disposed atop the sloped heat transfer device 16A with the heat transfer device absorbing heat from the substance S. This embodiment of the heat transfer device 16A is preferably sloped to move the beverage toward the valve 17 to facilitate complete evacuation of the contents S of the pouch 18.

FIG. 2 provides a second embodiment of the system 10 for cooling a commercial beverage box 12. As with the first embodiment, the coolant 14 is housed in a leak-proof heat transfer device 16B. The heat transfer device 16B is positioned in a pocket 28 on the side of the flexible plastic pouch 18 containing substance S for which cooling is desired. This variant of the heat transfer device 16B extends longitudinally along the pouch 18 to extract as much heat as possible from substance S thereby lowering the temperature as expeditiously as possible.

FIG. 3 provides a third embodiment of the system 10 for cooling a commercial beverage box 12. In this embodiment the coolant 14 is contained within a leak-proof heat transfer device 16C. This embodiment of the heat transfer device 16C is positioned beneath the pouch 18 and facilitates the transfer of heat from the substance S along the entire lower surface of the pouch 18.

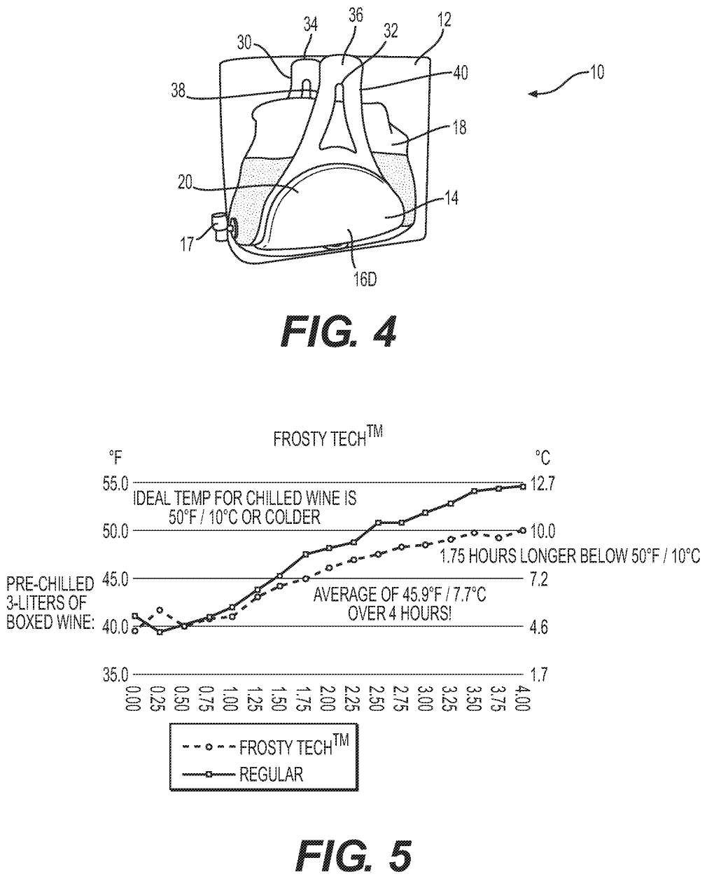

FIG. 4 provides a fourth embodiment of the system 10 for cooling a commercial beverage box 12. In this embodiment the coolant 14 is contained within a leak-proof heat transfer device 16D. This embodiment of the heat transfer device 16D is configured similarly to a hammock which effectively cradles the pouch 18 on two sides and the bottom of the pouch 18. Restraining flaps 30, 32 of the heat transfer device include slots 34, 36 extending between the two edges 38, 40 of the restraining flaps. The slots 34, 36 are configured to allow for insertion of the cardboard box flaps to restrain the heat transfer device 16D in place and prevent slippage.

The heat transfer device 16 disclosed herein may be in fabricated in a wide range of shapes as noted above to include a truncated cone as will be discussed in greater detail below as well as shaped as a wrap, a flat pack or even an angled wedge to mention just a few of the physical configurations that are contemplated with this disclosure.

In a typical scenario, the various heat transfer device 16A-D embodiments along with the substance S filled pouch 18 is placed into a residential, commercial or industrial refrigerator which preferably maintains a temperature in the range of from about 35° to 38° F. The refrigerator facilitates the phase change of the coolant 14 by extracting thermal energy from the coolant equivalent to at least the heat of solidification. A key detail with this system and method is that solidification of the coolant 14 takes place at a temperature that is at or above the temperature achieved by a properly functioning residential, commercial or industrial refrigeration unit and specifically does not require the lower temperatures of the freezer compartments of those units. In other words, the heat transfer device, in whatever physical configuration is selected, contains a coolant 14 that can be cooled to a temperature to remove sufficient energy to cause solidification.

The heat transfer device 16A-D requires no activation other than simply cooling the device 16A-D below the phase change temperature T1. This causes the coolant 14 to give up the heat of solidification. Once the heat transfer device 16A-D and substance S are removed from the cooling system and placed into the working environment the thermal energy transfer from the substance S to the coolant 14 commences. Thermal energy is transferred from the substance to the heat transfer device allowing the substance to maintain a lower temperature.

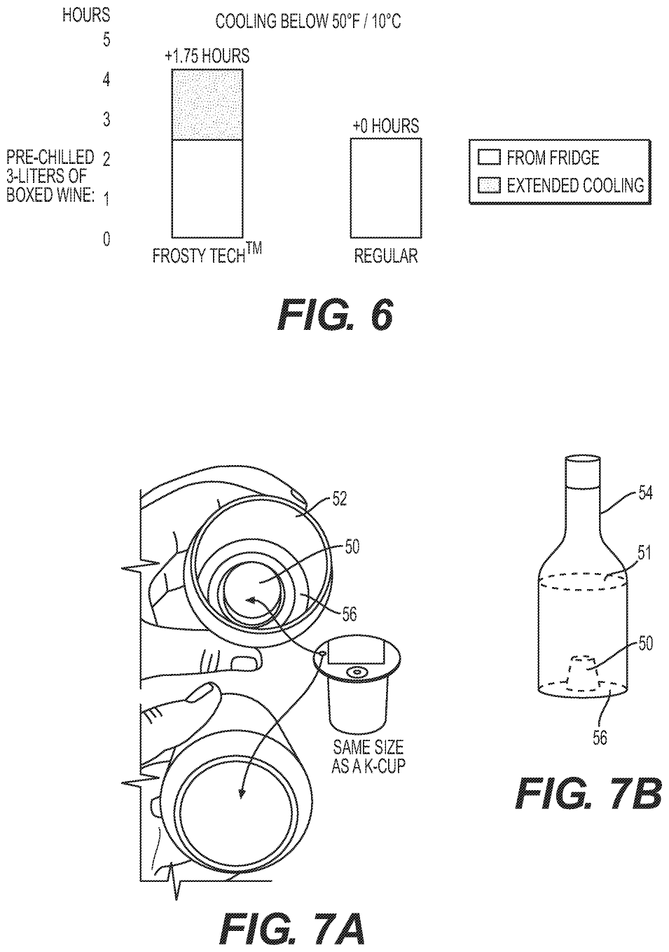

Experimental data, depicted in graphical form at FIG. 5, reveals the temperature increase profile associated with a standard 3-liter box of wine with, and without, the utilization of a 1.5 lb. (0.68 kg) cooling device 16 in the form of a multi-layered flexible bag filled with a coolant 14. The ambient air temperature during the experimentation was 70° F. and the ideal temperature for consuming the wine is considered by those knowledgeable to be at or slightly below 50° F. The data, as shown in FIG. 6, reveals that the wine, without active cooling, exceeds 50° F. after about 2.5 hours while the actively cooled wine remains below 50° F. for an additional 1.75 hours all the while exposed to an ambient environment at 70° F. The active cooling device 16 maintained the wine contents at or below 50° F. seventy-percent longer than a wine pouch that is not actively cooled with the system disclosed herein.

In another application, the heat transfer device 50 is immersed within the substance S1, such as beer, soda or wine, within for example, an aluminum can 52 or a bottle 54, as seen in FIGS. 7A and 7B. In these embodiments, the heat transfer device 50 is configured for securement to the base of the beer can 52 or bottle 54. The heat transfer device 50 being fully immersed in the substance S1 can readily absorb thermal energy from the substance S1 by conduction and facilitate a reduced rate of temperature increase of the substance S1 due to heat transfer from the ambient environment. The heat transfer device 50 is preferably secured, for example with a non-toxic adhesive, to one of the interior surfaces 56 of the can 52 or bottle 54 to prevent rattling of the heat transfer device 50 against the interior surfaces 56 when being handled by the consumer.

The heat transfer device 50 illustrated in FIGS. 7A and 7B may alternatively be a in the form of a small, flexible, leak resistant pouch that is secured to the bottom or even the side of the beverage can 52. The leak resistant pouch provides cooling by having the endothermic salt or other designated coolant contained within the pouch absorb heat from the beverage. When the phase change materials in the flexible heat transfer pouch reach the temperature at which they change phase (their melting temperature) they absorb large amounts of heat at an almost constant temperature thereby providing a cooling effect to the beverage within the can.

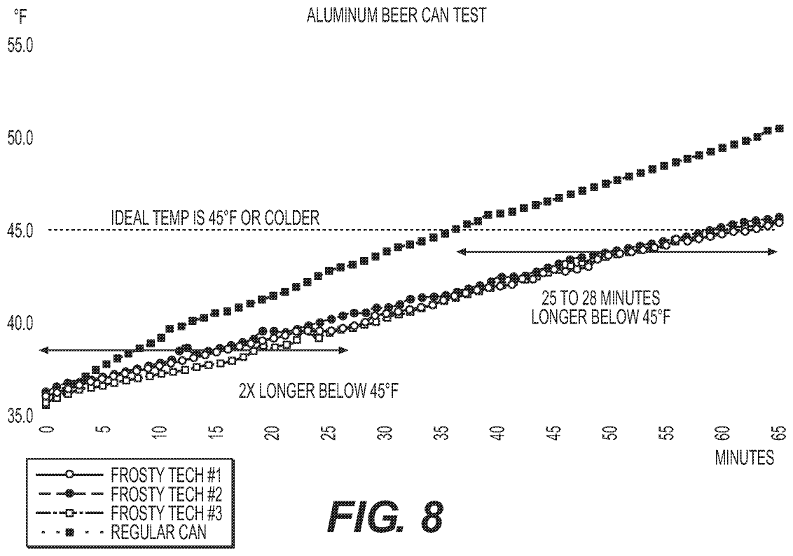

FIG. 8 reveals data in graphical form derived from testing of an active cooling heat transfer device 50 in an aluminum can. The three distinct graphed lines reveal three different configurations of the heat transfer device 50 (#1, #2 and #3) that are contained within the aluminum can 52. Can No. 1 employs a thin plastic walled cup heat transfer device. Can No. 2 employs an aluminum tube and Can No. 3 employs a clear plastic dome shape container. Can No. 4 is a traditional aluminum beverage container without any active cooling included.

Each of the three heat transfer device embodiments 50 graphed in FIG. 8 contain the same coolant; however, the heat transfer device container in each is fabricated from a different material, exists in a different physical configuration, has different costs, and exhibits nominally different heat transfer characteristics. Each configuration; however, provides active cooling that maintains the beverage at a desired temperature for a longer period-of-time as compared to a non-actively cooled beverage. The heat transfer devices 50 employed in each of three distinct cans contains approximately 50 ml of coolant 14. Can numbers 1-4 contain 11.4 ounces, 10.9 ounces, 9.5 ounces and 12 ounces of beer respectively. Can #4 contains no heat transfer device and the preferred temperature for consumption of beer is at approximately 45° F.

The graphical data in FIG. 8 reveals that after being cooled to approximately 36° F. in a refrigerator, the beverage contents of the three actively cooled cans maintains a temperature below 45° F. for 25 to 28 minutes longer than the beverage that is not actively cooled. The ambient environmental temperature being 70° F. for the testing of all four of the containers. According to the data, at 65 minutes from removal from the refrigerator the contents of the container that is not actively cooled (No. 4) has increased to a temperature of approximately 51° F. whereas the temperature of the contents of the actively cooled cans is approximately 45° F., or the optimal temperature for beer consumption.

The graphical data also reveals that the actively cooled cans (Nos. 1-3) stay at a temperature below 40° F. for approximately twice the amount of time as that of the can (No. 4) with no active cooling. Moreover, the three actively cooled cans are able to maintain a beverage temperature below 45° F. for at least 25 minutes, and longer with the heat transfer device 50 designs in Can Nos. 1 and 2, as compared to the beverage without active cooling.

Additional advantages of the active cooling system disclosed herein are that the 50 ml (1.69 ounces) heat transfer device 50 would not necessitate a significant increase in the height of the can. Currently, the indent, or rounded punt, at the base of beer cans displaces about 10 ml of beverage. Removing the punt and including a heat transfer device would only require a volumetric increase of 40 ml which could be accomplished with a very slight increase in the height of the beverage container. There would be no need to change the diameter of the can to increase the volume, only the height of the container need be altered.

Removing the punt does not jeopardize the physical integrity of the can 52 once it is filled with the beverage and is placed under pressure due to the release of gases contained within the beverage. The lower can surface 56 that previously was indented (the punt) is now covered by the heat transfer device 50. The outer circumferential edge 58 of the heat transfer device 50 is closely spaced from, or in direct contact with the tubular wall 60 of the beverage container 52 thereby reducing the potential for exertion of excessive pressure at the center of the punt. The heat transfer device effectively redistributes the internalized pressure from causing a protruding of the lower can surface 56 to nearer the tubular wall 60 of the can 52 where metallic or plastic deformation is less likely to occur.

Only a de minims amount of additional plastic (for plastic beverage containers) or aluminum (for aluminum beverage containers) would be required for increasing the volume of the container to utilize the heat transfer devices 50. A conservative estimate is that only about 2-3 grams of additional container material, i.e., aluminum or plastic, is needed to return the container height to a size sufficient to contain 12 fluid ounces of beverage while also housing the heat transfer device 50. Importantly, the heat transfer device is visually unobtrusive to a consumer of the substance and the vessel modification disclosed herein does not require any change in substance consumption habits as compared to consumption behavior for a substance from a similar vessel not employing the disclosed cooling system. The changes to the container dimensions detailed above require at most a minor modification, and potentially no physical modifications but only changes to settings of existing vessel filling and packaging systems to implement the heat transfer device disclosed herein.

Additionally, the system as disclosed herein requires no shaking, simply remove the beverage container from the refrigerator after a sufficient period to allow the heat of solidification to be extracted from the coolant 14. Standard refrigeration systems found in residences, as well as commercial and industrial establishments, can lower the temperature of the heat transfer device 50 to a temperature of approximately 37° F. which is sufficient to allow solidification of the coolant 14 contained within the heat transfer device 50.

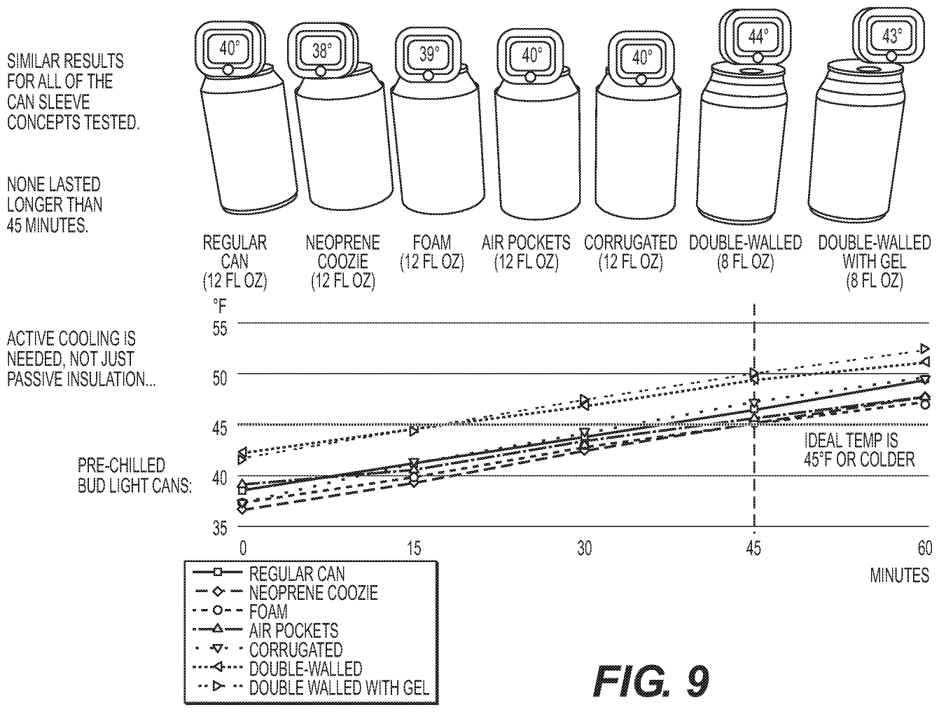

FIG. 9 reveals that passively insulated beverage containers, without any active cooling as is detailed above, tend to rapidly experience beverage temperature gain when exposed to an ambient temperature of 70° F. and the beverage contents exceed 45° F. in about 45 minutes after being initially cooled to 37° F. The test specimens included: (1) a regular aluminum beverage container with no liner; (2) a neoprene koozie; (3) a foam liner; (4) an air pocketed foam liner; (5) a corrugated liner; (6) a double walled liner; and (7) a double walled liner with gel.

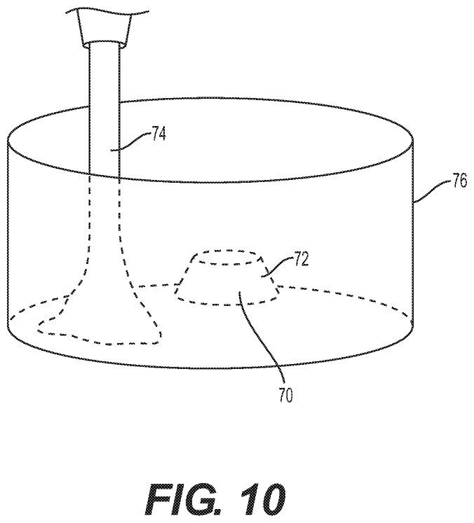

A similar embodiment of a heat transfer device 70 may also be utilized for lower temperature applications. As seen in FIG. 10, a purely exemplary truncated cone shaped heat transfer device 70 with a low solidification temperature coolant 72 is employed to maintain for as long as possible the temperature of ice cream that is removed from a freezer. During packaging of the ice cream, the heat transfer device 70 is positioned at the bottom of the container and is surrounded by the liquified ice cream 74 that is poured into the container 76.

This embodiment of the heat transfer device 70 contains a formulation of coolant 72 that has a lower solidification temperature than that which would typically be used for cooling of beverages. The solidification temperature of the coolant 72 is preferably in the range of between −5 F° and 0° F. or about the temperature at which most residential and commercial freezers operate. Ice cream is easy to dip at temperatures between 6° F. and 10° F. The temperature of the ice cream rapidly rises to that range when exposed to typical ambient temperatures (70° F. for testing purposes) and preferably should not rise much above that ideal dipping temperature range before being consumed to retain the desired consistency, texture and flavor.

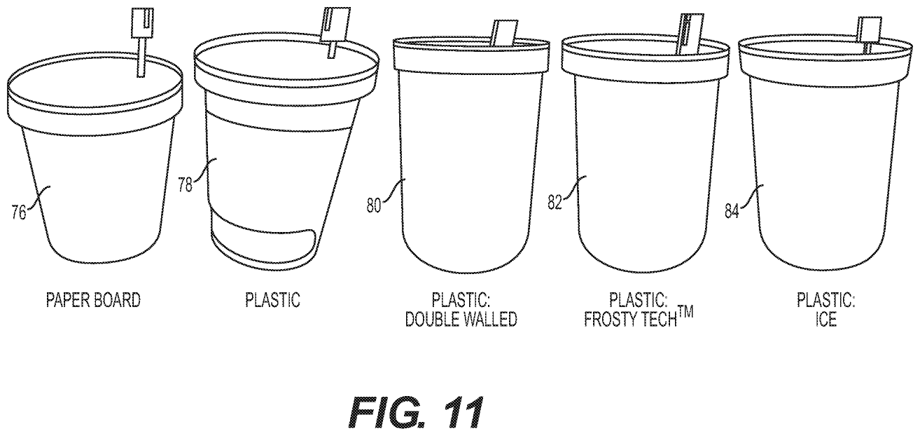

In yet another embodiment, as shown in FIG. 11, ice cream packaged in single serving containers has the commonly experienced propensity to melt quickly once exposed to the elevated temperatures of the ambient environment. Ice cream, as previously noted, is ideally maintained in residential, commercial or industrial coolers at temperatures between −5° F. and 0° F. and begins to actively melt at temperatures above 10° F. Take home ice-cream is responsible for annual sales of about $6.8 billion according to MarketLine™. There exists a substantial market for single serving containers of ice cream that can maintain the ice cream at a lower temperature and forestall rapid melting, particularly when the ambient temperature exceeds 75° F.

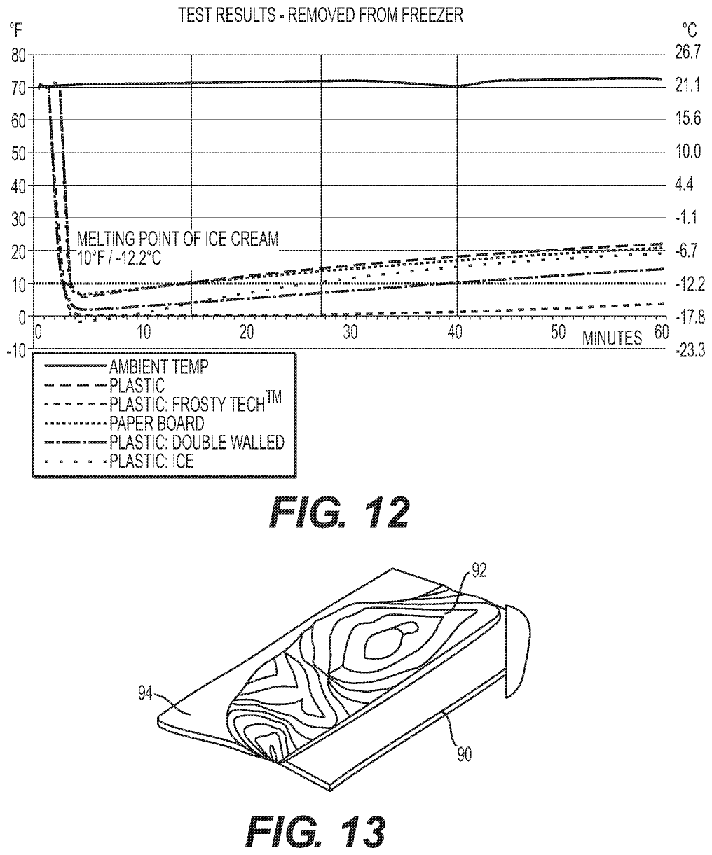

FIG. 12 includes performance data on five separate containers to include 1) a paper board container 76, 2) a plastic container 78, 3) a plastic double walled container 80, 4) a container utilizing the coolant as disclosed herein 82, and 5) a double walled plastic container but with a thin layer of ice disposed between the inner and outer walls of the container. Container numbers 1 and 2 are very traditional paper board and thin plastic wall respectively with nearly no insulating capacity. Container number 3 provides greater insulating value than either container numbers 1 or 2 but does not provide any active cooling. Container number 5 relies upon the cooling effect of ice disposed between the walls of the container to counteract the transfer of heat from the environment to the ice cream.

With container number 4 the cooling power is magnified because the coolant has a lower freezing point and a greater heat of fusion by volume than does ice and can absorb a greater amount of energy from the ice cream transitioning from a solid to a more liquid phase. The coolant 72, with a lower freezing point than water, can better stabilize the temperature of the ice cream closer to and preferably below the ice cream melting point for a longer duration than ice disposed between the double walls as with container number 5 and certainly longer than the passively insulated containers.

In this example, each container held 14 fluid ounces (414 ml) of ice cream and was cooled to approximately 0° F. The ice cream was ultimately exposed to an ambient temperature of 70° F. The test data in FIG. 12 reveals that only the container system disclosed herein can maintain the temperature below 10° F. for more than 60 minutes. None of the container designs referenced above, except No. 4, can maintain the temperature below 10° F. for more than 40 minutes. Container design No. 4 is; however, able to maintain the temperature below 10° F. for approximately 85 minutes, or more than twice as long as any of the other four containers and more than five times longer than a plain plastic or coated paper container.

In yet another embodiment of the system disclosed herein is a cooling pad 90 for maintaining the temperature of, for example, a salmon filet 92, as shown in FIG. 13, that has been laid out on the counter of a residence or restaurant and that will undergo baking, broiling or frying. Particularly in a warm kitchen, foods such as fish are subject to rapid bacterial growth which can lead to gastrointestinal ailments by those who consume the food unless the food is very meticulously prepared to include exposure to sufficiently high temperatures to kill the bacteria. In addition, when some foods, such as fruits, warm they can lose flavor and therefore maintaining many foods at below room temperature can retard flavor loss.

The flexible, foldable and rollable pad 90 is filled with a coolant material 94 and the entire pad is placed within a refrigerator well in advance of the time for cooking. When needed to cool the food, the coolant 94 housed within the pad 90 which is then cooled to the point where the heat of solidification has been extracted by the refrigeration system and the coolant is in a solid phase. The food to be prepared, such as the salmon filet, is placed atop the pad 90 and heat is extracted from the food maintaining the temperature and retarding bacterial growth and preserving the flavor of the food at a lowered temperature.

Alternative operating scenarios provide that for use with frozen foods, the phase change material of the rollable pad 90 is to have a melting point in the range of about −5° F. to 5° F., which is lower than the freezing point of nearly all foods since they are water based. This means that the coolant will melt first (absorbing heat from the surroundings of the coolant), keeping the frozen goods frozen even when removed from a cold environment in transit or when the consumer carries the consumable home in a shopping bag. Cooling the consumable this aggressively minimizes moisture loss which preserves the appearance and flavor as well as extending the shelf-life of the consumable.

For refrigerated goods, the coolant in this embodiment has a melting point of 35° F. to 55° F., which is higher than the freezing point of the consumables. This means that prior to completely melting, the frozen coolant extracts the heat of fusion from the nearby consumables thereby keeping the consumables cool. This aggressive cooling process decreases the potential for the consumables to experience a temperature increase which could result in undesirable deleterious microbial growth and diminish the flavor of the consumable. As with all embodiments disclosed herein, the coolant in the heat transfer device may be recharged by placing the heat transfer device inside of a refrigerated environment.

In one embodiment, the coolant 14 utilized by the heat transfer device 12 of the system 10 undergoes a phase change from liquid to solid upon placement into an environment with an ambient temperature preferably in the range of from about 35° to 38° F. The temperature at which the coolant supports phase change from liquid to solid may be precisely calibrated with the addition of one or more constituents and a preferred coolant has an enthalpy of fusion in the range of about 50 kJ/kg to 350 kJ/kg at 0° C.

The enthalpy of fusion of the coolant 14, also known as (latent) heat of fusion, is the change in its enthalpy resulting from providing energy, typically heat, to a specific quantity of the coolant to change its state from a solid to a liquid, at constant pressure. For example, when melting 1 kg of ice, 333.55 kJ of energy is absorbed with no temperature change. The heat of solidification (when the coolant changes from liquid to solid) is equal and opposite.

Phase Change Material Options

The coolant 14 disclosed herein are phase change materials with a high heat of fusion and solidification. The selected phase change materials have the capacity to store and release large quantities of energy. Heat is released or absorbed when the coolant 14 changes from a solid to liquid and vice versa. The coolant 14 continues to absorb heat without any significant rise in temperature until all the materials are converted to a liquid phase. When ambient temperature drops around the liquid material, the coolant solidifies, releasing stored heat. A significant number of phase change materials are available in any desired temperature range from 5° C. up to 190° C. These phase change materials can store from 5 to 14 times more heat per unit volume as compared with conventional storage of materials such as rock, water or masonry. The phase change materials are classified according to organic, inorganic and eutectics.

Organic Phase Change Materials

The organic phase change materials are bio-based or paraffin or carbohydrate and lipid derived. The advantages of organic materials include: (1) Freeze without much undercooling; (2) Ability to melt congruently; (3) Self nucleating properties; (4) Compatibility with conventional material of construction; (5) No segregation; (7) Chemically stable; (8) High heat of fusion; (9) Safe and non-reactive; (10) Recyclable; (11) Carbohydrate and lipid based phase change materials can be produced from renewable sources. A disadvantage of organic phase change materials is their low thermal conductivity in their solid state wherein high heat transfer rates are required during the freezing cycle.

Inorganic Salt Hydrate Phase Change Materials

Inorganic phase change materials, also known as salt hydrates, are an alternative to organic phase change materials. The advantages of these materials are that they (1) Freeze without much undercooling; (2) Ability to melt congruently, (3) Self nucleating properties; (4) Compatibility with conventional material of construction; (5) No segregation; (6) Chemically stable; (7) High heat of fusion; (8) Safe and non-reactive; (9) Recyclable; (10) Carbohydrate and lipid based phase change materials can be produced from renewable sources. The disadvantage of inorganic phase change materials is that they have low thermal conductivity in their solid state, their volumetric latent heat storage capacity can be low and they are flammable. Flammability can be partially alleviated by specialized containment, or by incorporating environmentally friendly fire retardants.

Exemplary inorganic salt hydrates include urea (CO(NH₂)2), potassium fluoride dihydrate (KF₂(H₂O), potassium chloride (KCl), potassium bromide (KBr), potassium iodide (KI), potassium nitrite (KNO₂), potassium nitrate (KNO₃), potassium thiosulfate pentahydrate (K₂S₂O₃.5H₂O), potassium cyanide (KCN), potassium cyanate (KCNO), potassium thiocyanide (KCNS), sodium perchlorite (NaClO₃), sodium perchlorate (NaClO₃), sodium perchlorite dihydrate (NaClO2.H₂O), sodium bromide dihydrate (NaBr.2H₂O), sodium nitrite (NaNO₂), sodium nitrate (NaNO₃), sodium acetate trihydrate (NaC2H3O₂.3H₂O), sodium thio sulfate pentahydrate (Na₂S2O₃.5H₂O), sodium cyanide dihydrate (NaCN.2H₂O), sodium cyanate (NaCNO), ammonium chloride (NH₄Cl), ammonium bromide (NH₄Br), ammonium iodide (NH₄I), ammonium iodate (NH₄IO₃), ammonium nitrite (NH₄NO₂), ammonium nitrate (NH₄NO₃), ammonium cyanide (NH₄CN), ammonium thiocyanide (NH₄CNS), silver nitrate (AgNO₃) and rubidium nitrate (RbNO₃).

Eutectics

Eutectics are defined as the one mixture of a set of substances able to dissolve in one another as liquids that, of all such mixtures, liquefies at the lowest temperature. If an arbitrarily chosen liquid mixture of such substances is cooled, a temperature will be reached at which one component will begin to separate in its solid form and will continue to do so as the temperature is further decreased. As this component separates, the remaining liquid continuously becomes richer in the other component, until, eventually, the composition of the liquid reaches a value at which both substances begin to separate simultaneously as an intimate mixture of solids. This composition is the eutectic composition and the temperature at which it solidifies is the eutectic temperature; if the original liquid had the eutectic composition, no solid would separate until the eutectic temperature was reached; then both solids would separate in the same ratio as that in the liquid, while the composition of the remaining liquid, that of the deposited solid, and the temperature all remained unchanged throughout the solidification.

Latent heat of fusion phase change materials are widely being used in thermal industries like food industry, process industry and transportation. ‘Eutectic System’ is used in refrigeration system which absorbs and liberates heat at constant imparted temperature. Eutectic materials have a large latent heat of fusion. This property of the material makes it popular for use in refrigeration systems. Eutectic is a mixture of two or compounds in proportion having freezing point less than that of the individual compound. Eutectic heat transfer devices 12 may be installed in packaging containing consumables such as beverages and pharmaceuticals in order to maintain the product of concern at or below a specified temperature. Eutectic heat transfer devices can be utilized for as many as nine to twelve hours with one time freezing. Once converted to the solid phase the operation of the eutectic heat transfer device is silent and is a reliable source of cooling for a specific time span.

Having shown and described various embodiments of the disclosed system, further adaptations of the system described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Moreover, the order of the components detailed in the system may be modified without limiting the scope of the disclosure.

We claim:

1. A system for cooling a substance, comprising:
a heat transfer device comprising a coolant housed internal to a container, the coolant having a first phase change temperature wherein at the phase change temperature the coolant changes from a liquid phase to a solid phase and releases heat to the ambient environment;
the heat transfer device positioned in at least one of (1) internal to a vessel containing a substance, (2) in full or partial contact with the vessel containing the substance, and (3) closely spaced from the vessel containing the substance; wherein the temperature of the vessel, heat transfer device and substance is lowered by placement into an environment with a temperature T1 thereby causing the coolant to undergo a change from a liquid phase to a solid phase; whereupon removal of the vessel and heat transfer device from the cooled environment and exposure to an ambient temperature T2, greater than temperature T1, the temperature of the substance and vessel transition from temperature T1 to ambient temperature T2 thereby causing an overall temperature increase of the vessel, the substance therein and the heat transfer device; the coolant within the heat transfer device maintains a temperature T1 while thermal energy is absorbed from the substance until energy equivalent to the heat of fusion for the entire mass of coolant has been absorbed into the coolant causing the coolant to return to a liquid phase, the rate of temperature change of the substance from T1 to T2 being retarded relative to a vessel not utilizing a heat transfer device.

2. The system of claim 1, wherein the heat transfer device is shaped as a truncated cone.

3. The system of claim 1, wherein the heat transfer device is shaped as a wrap.

4. The system of claim 1, wherein the heat transfer device is shaped as a flat pack.

5. The system of claim 1, wherein the heat transfer device is shaped as an angled wedge.

6. The system of claim 1, wherein the coolant is comprised of a salt hydrate solution.

7. The system of claim 1, wherein the coolant is comprised of an organic material.

8. The system of claim 1, wherein the coolant is comprised of an inorganic material.

9. The system of claim 1, wherein the coolant is comprised of a paraffin material.

10. The system of claim 1, wherein the coolant is metallic composition in suspension.

11. The system of claim 6, wherein the salt hydrate coolant may undergo repeated phase changes without a decrease in the functionality of the coolant.

12. The system of claim 1, wherein the heat transfer device is visually unobtrusive to a consumer of the substance.

13. The system of claim 1, wherein the vessel configuration does not require modification of existing vessel filling and packaging systems.

14. The system of claim 1, wherein the heat transfer device is secured to a bottom surface of the vessel.

15. The system of claim 1, wherein the heat transfer device is secured to a side surface of the vessel.

16. The system of claim 1, wherein the heat transfer device is secured to an inside surface of the vessel.

17. The system of claim 1, wherein the heat transfer device is secured to an outside surface of the vessel.

18. The system of claim 1, wherein utilization by the consumer of the system cooled substance within the vessel does not require any change in substance consumption habits as compared to consumption behavior for a substance from an identical vessel not employing the disclosed cooling system.

19. The system of claim 1, wherein the phase change temperature T1 of the coolant may be modified with changes in chemical constituents of the coolant.

20. The system of claim 1, wherein the coolant undergoes phase change from liquid to solid when exposed to a temperature in the range of from about 35° to 40° F.

21. The system of claim 1, wherein the coolant has an enthalpy of fusion in the range of from about 50 kJ/kg to 350 kJ/kg.

22. The system of claim 1, wherein the substance is a liquid.

23. The system of claim 1, wherein the substance is semi-solid.

24. The system of claim 1, wherein the vessel is an aluminum can.

25. The system of claim 1, wherein the vessel is a glass bottle.

26. The system of claim 1, wherein the vessel is a composite container.

27. The system of claim 1, wherein the vessel is a paperboard container.

28. The system of claim 1, wherein the vessel is a plastic container.

29. The system of claim 1, wherein the vessel is a bag-in-box.

30. The system of claim 1, wherein the vessel is a foam tray.

31. A system for cooling a substance, comprising:
a heat transfer device comprising a coolant housed internal to a container, the coolant having a first phase change temperature wherein at the phase change temperature the coolant changes from a liquid phase to a solid phase;
the heat transfer device positioned in at least one of (1) internal to a vessel containing a substance, (2) in full or partial contact with the vessel containing the substance, and (3) closely spaced from the vessel containing the substance; wherein the temperature of the vessel, heat transfer device and substance is lowered by placement into a cooling unit at a temperature T1 thereby causing the heat of solidification to be removed from the coolant and the coolant to undergo a change from a liquid phase to a solid phase;
whereupon removal of the vessel and heat transfer device from the cooling unit and exposure to an ambient temperature T2, warmer than temperature T1, the temperature of the substance and vessel transition from temperature T1 to ambient temperature T2 thereby causing an overall temperature increase of the vessel, the substance therein and the heat transfer device; wherein,
the coolant within the heat transfer device maintains a temperature T1 while thermal energy is absorbed from the substance until energy equivalent to the heat of fusion has been absorbed into the coolant causing the coolant to return to a liquid phase, the rate of temperature change of the substance from T1 to T2 is retarded relative to a vessel without a heat transfer device in the same ambient environment.

32. The system of claim 31, wherein the coolant undergoes phase change from liquid to solid when exposed to a temperature in the range of from about −5° to 0° F.

33. The system of claim 31, wherein the coolant is salt hydrate.

34. The system of claim 33, wherein the salt hydrate is from the group consisting of urea (CO(NH₂)2), potassium fluoride dihydrate (KF₂(H₂O), potassium chloride (KCl), potassium bromide (KBr), potassium iodide (KI), potassium nitrite (KNO₂), potassium nitrate (KNO3), potassium thiosulfate pentahydrate (K₂S₂O₃.5H₂O), potassium cyanide (KCN), potassium cyanate (KCNO), potassium thiocyanide (KCNS), sodium chloride (NaCl), sodium perchlorite (NaClO₃), sodium perchlorate (NaClO₃), sodium perchlorite dihydrate (NaClO₂.H₂O), sodium bromide dihydrate (NaBr.2H₂O), sodium sulfate (Na₂SO₄), sodium nitrite (NaNO₂), sodium nitrate (NaNO₃), sodium acetate trihydrate (NaC2H3O₂.3H₂O), sodium thio sulfate pentahydrate (Na₂S2O₃.5H₂O), sodium cyanide dihydrate (NaCN.2H₂O), sodium cyanate (NaCNO), ammonium chloride (NH₄Cl), monobasic ammonium phosphate (NH₄H₂PO₄), ammonium bromide (NH₄Br), ammonium iodide (NH₄I), ammonium iodate (NH₄IO₃), ammonium nitrite (NH₄NO₂), ammonium nitrate (NH₄NO₃), ammonium cyanide (NH₄CN), ammonium thiocyanide (NH₄CNS), silver nitrate (AgNO₃) and rubidium nitrate (RbNO₃).

35. A method for cooling a substance, comprising:
(a) providing a heat transfer device comprising a coolant housed in a container, the coolant having a phase change temperature T1 at which the coolant changes from a liquid phase to a solid phase;
(b) cooling the heat transfer device and the coolant housed therein at or below the phase change temperature; and
(c) placing a substance in at least one of contact with and closely spaced to the heat transfer device such that thermal energy is transferred from the substance into the coolant by at least one of conduction, convection and radiation through the container.

36. The method of claim 33, wherein the container is comprised of at least one of flexible walls and rigid walls.

37. The method of claim 33, wherein the coolant has an enthalpy of fusion in the range of from about 50 to 350 kJ/kg.

38. The method of claim 33, wherein the coolant is comprised of at least one of ammonium nitrate, potassium chloride, sodium chloride, sodium sulfate and monobasic ammonium phosphate.

39. The method of claim 33, wherein the substance is at least one of a liquid, a semi-solid and a solid.

40. The method of claim 39, wherein when the substance is in the form of a solid the heat transfer device is an adhesive backed label applied directly to the substance.

41. The method of claim 40, wherein when the substance is in the form of a liquid contained within a receptacle, the adhesive backed label is applied directly to the receptacle.
